(19) United States
(12) Patent Application Publication
(10) Pub. No.: US 2008/0257033 A1
(43) Pub. Date: Oct. 23, 2008

(54) Ice detection

(75) Inventor: Ronald N. Roberts, Duluth, MN (US)

Correspondence Address: MUETING, RAASCH & GEBHARDT, P.A., P.O. BOX 581336, MINNEAPOLIS, MN, 55458-1336, US

(73) Assignee: SHADIN, L.P., ST. LOUIS PARK, MN (US)

(21) Appl. No.: 11/788,809

(22) Filed: Apr. 20, 2007

(51) Int. Cl. G01W 1/00; G08B 19/02

(52) U.S. Cl. 73/170.26; 340/581

(57) ABSTRACT

Apparatus, methods, and systems for ice detection, e.g., ice detection using a reference probe and a collection probe to detect ice formation on an aircraft.

### BACKGROUND

The present invention relates generally to ice detection, e.g., ice detection on an aircraft in flight. More particularly, the present invention relates to methods of ice detection, ice detection systems, and apparatus for use in methods and systems of ice detection.

Ice detection may be useful in one or more various applications such as weather forecasting or determining the need for de-icing on vehicles, such as aircraft, etc. As such, ice detection apparatus are useful for detecting favorable icing conditions on many different objects including, but not limited to, aircraft, cars, boats, rockets, helicopters, buses, gliders, weather stations, weather towers, and semi-trailer trucks. For example, if an ice detection apparatus detects such favorable conditions, then action may be taken to remedy problems associated therewith.

Various ice detection apparatus have been described. For example, U.S. Pat. No. 4,730,485, issued 15 Mar. 1988 to Franklin et al. and entitled “Detector apparatus for detecting wind velocity and direction and ice accumulation” describes an elongate cylindrically shaped rod with electrical strain gauges mounted on a region of high stress of the rod to measure wind velocity and direction around the longitudinal axis of the rod or weight of accumulated ice on the rod as a function of time in relation to compression or tension on the strain gauges.

Also, for example, U.S. Pat. No. 4,745,804, issued 24 May 1988 to Goldberg et al. and entitled “Accretion Type Ice Detector” describes a probe exposed to the atmosphere where strain resulting from compressive stress of the probe is proportional to accretion of ice upon the probe.

Other ice detection apparatus have also been described which utilize various techniques for detecting the presence of ice on an object. For example, use of a vibrating probe, optical diffusion, acoustic pulses, and the deflection of a diaphragm have all been used for detection of ice on an object.

### SUMMARY

The present invention relates to ice detection on an object. In at least one embodiment or more, the present invention includes ice detection apparatus, methods, and systems for an aircraft in flight.

In one embodiment of an ice detection apparatus according to the present invention, the ice detection apparatus includes a reference probe, a collection probe, and a processing and control apparatus. The reference probe includes a reference probe element and the collection probe includes a collection probe element. The collection probe element is of the same configuration as the reference probe element. The processing and control apparatus is configured to receive data from the reference probe and the collection probe, wherein the processing and control apparatus compares the data from the reference probe and the collection probe to detect the presence of ice on the collection probe element.

In another embodiment of an ice detection apparatus according to the present invention, the ice detection apparatus includes a reference probe, a collection probe, and a processing and control apparatus. The reference probe includes a reference probe element. The collection probe includes a collection probe element. The reference probe and the collection probe are configured to be mounted on an aircraft such that both the reference probe element and the collection probe element have substantially identical exposure to an airstream when the aircraft is in flight. The processing and control apparatus is configured to receive data from the reference probe and the collection probe representative of aerodynamic drag on the reference probe element and the collection probe element, wherein the processing and control apparatus compares the data from the reference probe and the collection probe to detect the presence of ice on the collection probe element.

In yet another embodiment of an ice detection apparatus according to the present invention, the ice detection apparatus includes a reference probe and a collection probe. The reference probe includes a reference probe element, a force moment detection device for use in detecting a force moment applied to the reference probe element when the reference probe is mounted, and a heating element to heat the reference probe element. The collection probe includes a collection probe element and a force moment detection device for use in detecting a force moment applied to the collection probe element when the collection probe is mounted.

In one embodiment of a method for detecting the presence of ice formation on an aircraft in flight according to the present invention, the method includes providing a reference probe comprising a reference probe element and a collection probe comprising a collection probe element. The reference probe element and the collection probe element are mounted on the aircraft such that they both have substantially identical exposure to an airstream when the aircraft is in flight. The method further includes collecting data from the reference probe and the collection probe representative of aerodynamic drag on each of the reference probe element and the collection probe element and determining if ice is present on the collection probe element based on the data collected from the reference probe and the collection probe.

In another embodiment of a method for detecting the presence of ice formation on an aircraft in flight according to the present invention, the method includes providing a reference probe comprising a reference probe element and a collection probe comprising a collection probe element. The method further includes heating the reference probe element to prevent ice formation thereon while allowing ice to form on the collection probe element. The method further includes collecting data from the reference probe and the collection probe and determining if ice is present on the collection probe based on the data collected from the reference probe and the collection probe.

In one embodiment of a system for ice detection according to the present invention, the system includes a reference probe, a collection probe, a mounting structure, and a processing and control apparatus. The reference probe includes a reference probe element and a force moment detection device for use in detecting the force moment applied to the reference probe element when the reference probe is mounted. The collection probe includes a collection probe element and a force moment detection device for use in detecting the force moment applied to the collection probe element when the collection probe is mounted. Further, the collection probe element is of the same configuration as the reference probe element. The mounting structure is configured to mount the reference probe and the collection probe on an aircraft such that both the reference probe element and the collection probe element have substantially identical exposure to an airstream when the aircraft is in flight. The processing and control apparatus is configured to receive data from the reference probe and the collection probe representative of the force moment applied to the reference probe element and the collection probe element. Further, the processing and control apparatus compares the data from the reference probe and the collection probe to determine a difference between the force moment on the reference probe element and the force moment on the collection probe element so as to detect the presence of ice on the collection probe element when the aircraft is in flight.

The above summary of the present invention is not intended to describe each embodiment or every implementation of the present invention. Advantages, together with a more complete understanding of the invention, will become apparent and appreciated by referring to the following detailed description and claims taken in conjunction with the accompanying drawings.

### BRIEF DESCRIPTION OF THE DRAWING

FIG. 1 is a block diagram of an exemplary embodiment of an ice detection system including an ice detection apparatus according to the present invention.

FIG. 2 is a detailed block diagram of an exemplary embodiment of an ice detection system including an ice detection apparatus according to the present invention such as shown generally in FIG. 1.

FIG. 3 is a perspective view of an exemplary embodiment of a reference probe and a collection probe mounted as could be used in an ice detection apparatus according to the present invention such as shown generally in FIGS. 1 and 2.

FIG. 4 is an illustration disclosing cantilever force moment due to aerodynamic drag of various shapes at various airspeeds.

FIG. 5 is a block diagram of an embodiment of an ice detection method according to the present invention that may be implemented by an ice detection apparatus such as shown in FIGS. 1-3.

FIG. 6 is a block diagram of another embodiment of an ice detection method according to the present invention that may be implemented by an ice detection apparatus such as shown in FIGS. 1-3.

FIG. 7 is a block diagram of yet another embodiment of an ice detection method according to the present invention that may be implemented by an ice detection apparatus such as shown in FIGS. 1-3.

FIG. 8 is a block diagram of an embodiment of an ice detection apparatus malfunction detection method according to the present invention that may be implemented by an ice detection apparatus such as shown in FIGS. 1-3.

### DETAILED DESCRIPTION OF EXEMPLARY EMBODIMENTS

In the following detailed description of illustrative embodiments of the invention, reference is made to the accompanying figures of the drawing which form a part hereof, and in which are shown, by way of illustration, specific embodiments in which the invention may be practiced. It is to be understood that other embodiments may be utilized and structural changes may be made without departing from the scope of the present invention. Unless stated otherwise herein, the figures of the drawing are rendered primarily for clarity and thus may not be drawn to scale.

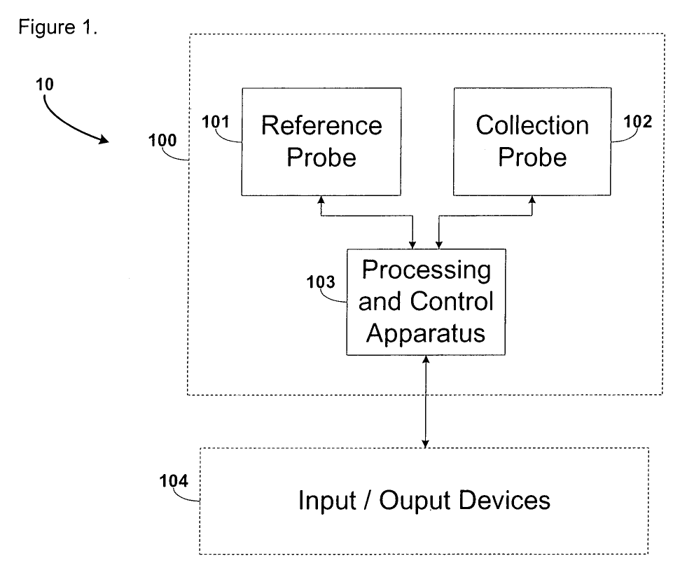

FIG. 1 shows a block diagram of an exemplary embodiment of an ice detection system 10 including an ice detection apparatus 100 according to the present invention. The ice detection apparatus 100, represented by a dashed rectangle, may include a reference probe 101, a collection probe 102, and a processing and control apparatus 103. The reference probe 101 and the collection probe 102 may be electrically, mechanically, and/or thermally coupled to the processing and control apparatus 103 (e.g., the reference probe 101 may be coupled allowing the reference probe 101 to be heated, the probes 101, 102 may be electrically coupled allowing data to be transmitted to the processing and control apparatus 103, etc.). The processing and control apparatus 103 may be electrically and/or mechanically coupled to input/output devices 104, represented by a dashed rectangle (e.g., the processing and control apparatus 103 may be electrically coupled to an ice detection indicator, such as a light emitting diode in the cockpit of an aircraft).

In at least one embodiment, the system 10 includes a mounting structure configured to mount the reference probe 101 and the collection probe 102 (e.g., to mount the probes 101, 102 on the outside of a vehicle, such as an aircraft).

The reference probe 101 and the collection probe 102 may include probe elements (e.g., portions of the probes 101, 102 that extend outside of the vehicle's skin and/or at a position where they may be subject to atmospheric conditions). In at least another embodiment, the reference probe 101 and the collection probe 102 include probe elements that are of the same configuration (e.g., the probe elements are of the same shape and size, such as identical probe elements mounted in the same location on a vehicle such that they are exposed to substantially the same conditions). For example, in one embodiment, the system 10 includes a mounting structure configured to mount the reference probe 101 and the collection probe 102 on a vehicle, e.g., an aircraft, such that the substantially identical reference probe element and the collection probe element have substantially identical exposure to an airstream around the vehicle, e.g., when an aircraft is in flight.

In at least one embodiment, the reference probe 101 includes a heating element to heat the reference probe element. Generally, the reference probe element is heated to prevent ice formation thereon. The collection probe 102 may also include a heating element to heat the collection probe element. Generally, the collection probe element is heated to clear ice formation thereon after ice has been detected. As such, generally, the collection probe 102 is not heated so as to allow ice formation thereon.

In at least one embodiment, the probes 101, 102 include force moment detection devices (e.g., strain gauges) that detect a force moment applied to a portion of the probes 101, 102 (e.g., representative of aerodynamic drag on the reference probe element and the collection probe element when an aircraft is in flight).

At least in one embodiment, the ice detection system 10 detects the presence of icing conditions while in flight. In this embodiment, the detector may use two probes, which are identically shaped, semi-circular cross-section rods that are presented to the free air stream. Further, a flat side of the probe may be oriented toward the direction of the wind. Further, each probe may be supported by a beam-type load-cell to measure the bending moment that results from the reaction of aerodynamic drag.

At least in another embodiment, the ice detection system 10 detects the formation of ice on a probe by measuring the resulting change in aerodynamic drag.

At least in another embodiment, the ice detection system 10 detects atmospheric icing conditions by employing an identically shaped reference probe for comparison to account for changes in vehicle speed and local airflow stream characteristics.

At least in another embodiment, the ice detection system 10 detects atmospheric icing conditions by sensing the change in aerodynamic drag, over time, due to ice formation, in order to confirm that ice is actually forming.

The processing and control apparatus 103 may receive data from the reference probe 101 and the collection probe 102. Generally, to determine if ice is present on the collection probe 102, the processing and control apparatus 103 compares the data from the reference probe 100 and the collection probe 102. In at least one embodiment, the processing and control apparatus 103 determines a difference between the force moment (e.g., measured using a strain gauge associated with each of the reference probe and the collection probe) on a heated reference probe element and the force moment on the collection probe element so as to detect the presence of ice on the collection probe element when the aircraft is in flight. Such force moments may be representative of aerodynamic drag on the reference probe element and the collection probe element. If ice is detected on the collection probe 102, then icing conditions are favorable, and ice formation on the vehicle surfaces (e.g., an aircraft engine inlet, wing, and/or tail) proximate to which the ice detection apparatus 100 is mounted, is likely.

The ice detection apparatus, methods, and systems according to the present invention may be useful for detecting favorable icing conditions on many different objects including but not limited to aircraft, cars, boats, rockets, helicopters, buses, gliders, weather stations, weather towers, and semi-trailer trucks. Further, ice detection apparatus, methods, and systems according to the present invention may be used on many different surfaces on the many different objects including, but not limited to, the wing, the engine, the engine air inlets, the nacelle, the tail, and the landing gear of an aircraft or any other similar vehicle. Further, the ice detection apparatus, methods, and systems according to the present invention may also be useful when applied to any vehicle where the detection of atmospheric icing conditions is beneficial.

Although ice detection according to the present invention may be used with a multitude of different objects, for simplicity, the exemplary embodiments provided herein are described in terms of ice detection used with an aircraft, e.g., an aircraft in flight. Further, the present invention can detect icing conditions surrounding the aircraft or specific portions of the aircraft such as the engine or nacelle.

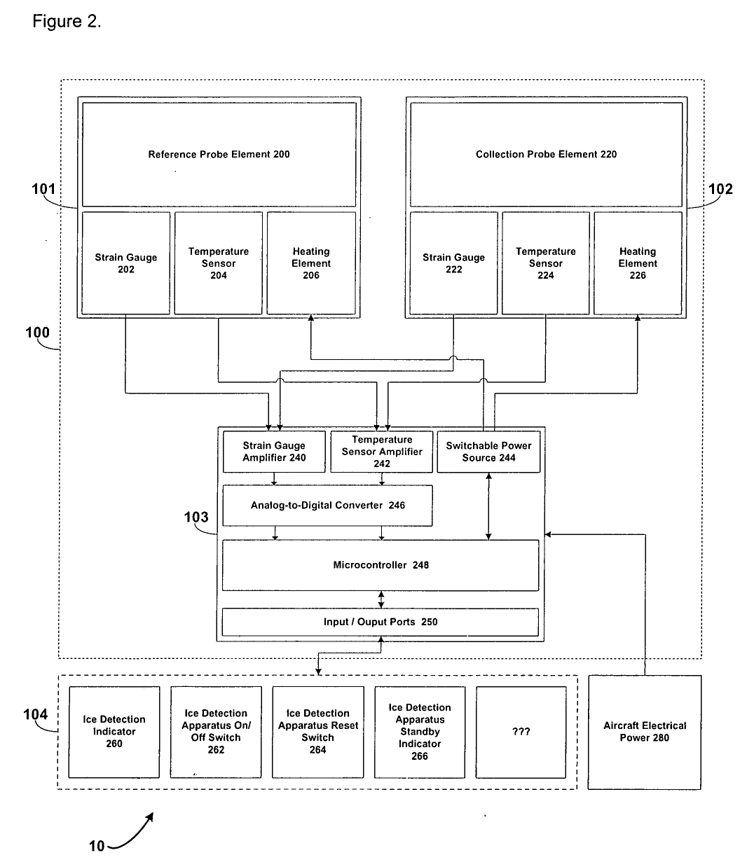

FIG. 2 shows a detailed block diagram of one exemplary embodiment of an ice detection system 10 including an ice detection apparatus 100 such as shown generally in FIG. 1 according to the present invention. As described with reference to FIG. 1, the ice detection apparatus 100 includes a reference probe 101, a collection probe 102, and a processing and control apparatus 103.

Reference probe 101, at least in one embodiment, generally may include a reference probe element 200, a strain gauge 202, a temperature sensor 204, and a heating element 206. Collection probe 102, at least in one embodiment, generally may include a collection probe element 220, a strain gauge 222, a temperature sensor 224, and a heating element 226.

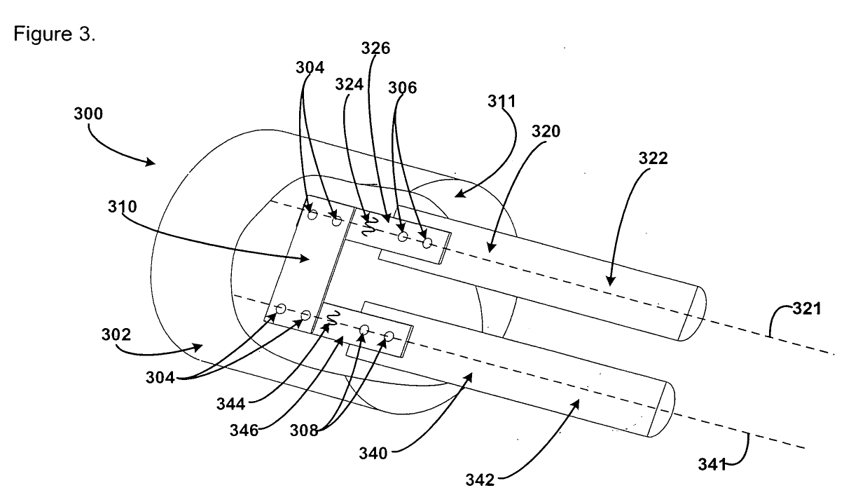

Generally, the reference probe element 200 and the collection probe element 220 are the portions of the reference probe 101 and the collection probe 102, respectively, that extend into the airstream surrounding the aircraft on which the ice detection apparatus 100 is mounted. The probe elements 200, 220 may be formed in any shape or size as to be a capable of providing aerodynamic drag (e.g., positive or negative) as the aircraft is in motion. For example, the probe elements 200, 220 may have a circular, rectangular, hexagonal, or triangular cross-section. However, the probe elements' 200, 220 shape does not need to be uniform. For example, the probe elements 200, 220 both may have a flat first surface facing the forward movement direction of the aircraft upon which the ice detection apparatus 100 is mounted and a rounded second surface facing the rearward movement direction of the aircraft (i.e., a semi-circle cross-section) as described herein with reference to FIG. 3. Further, for example, the probe elements 200, 220 may be circular rods with diameters of about ⅛ inch to about ½ inch. Yet further, for example, the probe elements 200, 220 may have an anemometer-style shape.

At least in one embodiment, each of the probe elements 200, 220 include an elongate body portion including a proximal end proximate the aircraft when mounted and a distal end distal from the aircraft when mounted. At least in one embodiment, the distal end extends to a distance of about 2 inches to about 6 inches from the surface of the aircraft on which the ice detection apparatus 100 is mounted. Any probe length will function as long as practical application limits are not violated (e.g., the probe must be long enough to not be greatly influenced by the airflow boundary layer and be located outside of any “ice shadow,” i.e., any location that is not impacted by ice due to the droplets trajectory at that location which is affected by the droplet size, airflow field, and the aircraft's trajectory).

Generally, for example, the elongate body of each of the probe elements 200, 220 has a length that extends along a respective element axis. When the probe elements 200, 220 are mounted, the element axis of the probe elements 200, 220 may be orthogonal to the surface of the aircraft (e.g., lie 90 degrees relative to a tangent at the point of contact of the probe with the skin surface at which it is mounted) or at any other angle that would allow for a sufficiently measurable cantilever force moment on the probe elements 200, 220 so as to allow the ice detection apparatus 100 to detect the presence of ice on the collection probe element 220 (e.g., to detect if icing conditions exist). For example, the element axis of the probe elements 200, 220 may lie relative to the surface of the aircraft at about 75 degrees to about 105 degrees.

Further, at least in one embodiment, the probe elements 200, 220 may have a cross-section height, i.e., a cross-section height that lies in a plane parallel to the element axis and normal to the generally forward motion of the aircraft, of about ⅛ inch to about ½ inch. Further, the probe elements 200, 220 may have a cross-section depth, i.e., a cross-section depth that lies in a plane parallel to the element axis and also in a direction parallel to the generally forward motion of the aircraft, of about ⅛ inch to about ½ inch. However, the probe elements 200, 220 do not need to be of a uniform cross-section height or depth throughout their length as the probe elements 200, 220 may be tapered, wavy, or have any other shape known to one skilled in the art that would be suitable for use in detecting the presence of ice as provided herein.

Further, the probe elements 200, 220 may be hollow or solid. The probe elements 200, 220 may be formed of materials such as, but not limited to, steel, aluminum, titanium, scandium, a polymer, a ceramic, and/or a copper alloy.

Although the embodiment in FIG. 2 only describes the use of two probes, an ice detection apparatus according to the present invention may use a single probe. For example, a single probe embodiment may only include a collection probe and would detect the presence of ice by comparing the data from the collection probe and stored, pre-calculated data of how the collection probe would function at a given temperature, air speed, wind speed, altitude, etc.

Although the embodiment in FIG. 2 only shows a single ice detection apparatus, the ice detection system according to the present invention may include a plurality of ice detection apparatus for detecting icing conditions on multiple surfaces of the aircraft, providing redundancy and accuracy, satisfying Federal Aviation Administration requirements, and/or any other reason known to one skilled in the art. Further, for example, the apparatus may include multiple reference probes and multiple collection probes (e.g., data therefrom may be averaged, one may be redundant for the other, etc.)

At least in one embodiment, the probe elements 200, 220 are of substantially the same configuration. For example, the probe elements 200, 220 may be substantially the same size and shape so as to produce the same aerodynamic drag effect when subjected to the same conditions. Further, for example, at least in one embodiment the probe elements 200, 220 may be located in the same approximate location (e.g., mounted side by side on an aircraft) so as to protrude into approximately the same airstream when the aircraft is in flight. However, the probe elements 200, 220 may also be located in different locations as long as they are subjected to similar conditions. For example, the collection probe element 220 may be mounted on a first aircraft wing while the reference probe element 200 may be mounted on a second opposite aircraft wing (e.g., in substantially the same position on such wings).

Further, for example, at least in one embodiment, the collection probe element 220 may be of a different configuration than the reference probe element 200. However, if the probe elements 200, 220 are not substantially the same size and/or shape, the processing and control apparatus 103 may need to be used to compensate for the differences that exist between the configurations of the probe elements 200, 220.

At least in one embodiment, the probe elements 200, 220 are fixedly attached to other portions of their respective probe 101, 102 by way of a mounting structure beneath the surface of the aircraft, outside of the external environment (e.g., a mounting structure as shall be described with reference to FIG. 3). The probe elements 200, 220 may be attached to other portions of their respective probe 101, 102 by rivets, bolts, welds, adhesives, friction staking, welds, brazed joints, and/or any other fastening technique known to one skilled in the art.

As shown in the embodiment of FIG. 2, each of the probes 101, 102 include a strain gauge 202, 222 to monitor the force moment applied to their respective probe elements 200, 220. As used herein, a strain gauge refers to any device capable of monitoring one or more forces applied on an object, e.g., a probe element. At least in one embodiment, the force moment being monitored generally corresponds to the aerodynamic drag on the probe elements 200, 220 when the aircraft is in flight. The strain gauges 202, 222 can be configured to only measure force moments from single direction or can be configured to measure force moments from multiple directions. Further, the strain gauges 202, 222 may each employ a plurality of strain gauges for measuring strain applied from different directions, measuring strain of different strengths, redundancy, forming a ¼ bridge, forming a ½ bridge, and/or any other reason known to one skilled in the art. For example, the strain gauges 202, 222 may be metallic-foil strain gauges, piezo-resistive strain gauges, beam-type load-cells, and/or any other strain gauges as would be known to one skilled in the art. The strain gauges 202, 222 may be any form of instrumentation that can give an indication of a cantilever force moment.

The strain gauges 202, 222 may be contained in a housing or other mounting structure and may be, therefore, protected from the exterior environmental elements. Further, the strain gauges 202, 222 are generally located proximate the proximal end of their respective probe element 200, 220. However, the strain gauges 202, 222 may be located in any suitable location on their respective probe 101, 102 as long as they provide the functionality required to provide ice detection according to the present invention. For example, a weather resistant strain gauge may be located outside of the housing directly on the probe element 200, 220. Generally, the strain gauges 202, 222 are mounted flush with or integrated directly into a deflectable section of the probes 101, 102. The strain gauges 202, 222 may be able to withstand temperatures ranging from about negative 40 degrees Fahrenheit to about 165 degrees Fahrenheit without damaging and/or malfunctioning. Further, the strain gauges 202, 222 may be configured so that they may be removable as to be replaceable if, for example, they become damaged and/or malfunction, or for any other reason known to one skilled in the art.

Generally, the strain gauges 202, 222 are coupled to the processing and control apparatus 103. For example, the strain gauges 202, 222 may be electrically coupled (e.g., aircraft cabling) to the strain gauge amplifier 240 of the processing and control apparatus 103 as described herein.

As previously described, the probes 101, 102 include temperature sensors 204, 224. The temperature sensors 204, 224 are used to monitor the temperature of their respective probe element 200, 220. The temperature sensors 204, 224 may be resistance thermometers, thermistors, thermocouples, infrared thermometers, and/or any other temperature sensors as would be known to one skilled in the art. The temperature sensors 204, 224 may be capable of measuring temperatures from about negative 65 degrees Fahrenheit to about 200 degrees Fahrenheit, and may be able to withstand temperatures ranging from about negative 65 degrees Fahrenheit to about 350 degrees Fahrenheit without damaging and/or malfunctioning. The temperature sensors 204, 224 may be a plurality of temperature sensors for monitoring the temperature at different areas of their respective probes 101, 102 and/or probe elements 200, 220, monitoring different temperature ranges, providing redundancy, and/or any other reason known to one skilled in the art.

The temperature sensors 204, 224 may be located within the inside and/or attached to the outside of their respective probe elements 200, 220. Generally, the temperature sensors 204, 224 are located wherever they may effectively measure the relative temperature of their respective probe element 200, 220. Further, the temperature sensors 204, 224 may be configured so that they may be removable as to be replaceable if, for example, they become damaged and/or malfunction, or for any other reason known to one skilled in the art.

The temperature sensors 204, 224 may be electrically coupled to the processing and control apparatus 103. For example, the temperature sensors 204, 224 may be electrically coupled (e.g., aircraft cabling or wirelessly) to the temperature sensor amplifier 242 of the processing and control apparatus 103 as described herein.

Further, at least in one embodiment, the strain gauges 202, 222 and temperature sensors 204, 224 may be wirelessly coupled to the processing and control apparatus 103. For example, the strain gauges 202, 222 and temperature sensors 204, 224 may include a transmitter to transmit to a receiver that may be included in the processing and control apparatus 103.

Further, as previously described, the probes 101, 102 include heating elements 206, 226 to heat their respective probe elements 200, 220 to prevent and/or remove ice formation thereon. For example, the heating elements 206, 226 may be bare nichrome wire/ribbons, calrods, heat lamps, positive thermal coefficient ceramics, peltier heaters, quartz incandescent tubes, and/or any other heating elements as would be known to one skilled in the art. Generally, the heating elements 206, 226 are capable of heating their respective probe elements 200, 220 from about 90 degrees Fahrenheit to about 150 degrees Fahrenheit.

In one or more embodiments, the heating elements 206, 226 may be a plurality of heating elements for heating different areas of their respective probe elements 200, 220, for heating at different temperature ranges, for providing redundancy, and/or for any other reason known to one skilled in the art. The heating elements 206, 226 may be located within the inside and/or attached to the outside of their respective probe elements 200, 220. For example, at least in one embodiment, an opening is defined in the probe element 200, 220 for receiving a heating element therein. Generally, the heating elements 206, 226 are located wherever they may effectively heat their respective probe elements 200, 220 so as to prevent and/or remove ice formation thereon. For example, in at least one embodiment, the reference probe element 200 is heated (e.g., continuously as the detection process is in operation) so as to prevent ice formation thereon while ice is allowed to form on the collection probe element 220. Further, for example, in at least one embodiment, the collection probe is heated to clear the ice from the collection probe after it has formed thereon and been detected by the apparatus 100.

The heating elements 206, 226 may be able to withstand temperatures ranging from about negative 65 degrees Fahrenheit to about 350 degrees Fahrenheit without damaging and/or malfunctioning. Further, the heating elements 206, 226 may be configured so that they may be removable so as to be replaceable if, for example, they become damaged and/or malfunction, or for any other reason known to one skilled in the art.

The heating elements 206, 226 may be electrically and/or thermally coupled to the processing and control apparatus 103. Generally, the heating elements 206, 226 are electrically activated and are coupled to a switchable power source 244 of the processing and control apparatus 103 as described herein. However, the heating elements 206, 226 may be heated by any other heating method known to one skilled in the art.

At least in one embodiment, each probe element 200, 220 may extend 4 inches into the air-stream and the pair will be located closely together, or otherwise located so that each probe does not affect the other's airflow field and, both probes have a nearly identical exposure to the airflow stream. The probes may have a cross-section height of 0.250 inches. Any cross-section height will function as long as practical application limits are not violated. Further, the probes can be most any shape and do not need to have a constant cross-section. Each probe may have internal provisions for heating to a roughly controlled temperature, in order to prevent the formation of ice and/or to shed any accumulated ice.

The processing and control apparatus 103 may include any components necessary to carry out the functionality described herein for the detection of ice conditions. As shown in FIG. 2 and as previously presented, the processing and control apparatus 103 may include, but is clearly not limited to, the strain gauge amplifier 240, the temperature sensor amplifier 242, and the switchable power source 244. Further, for example, the processing and control apparatus 103 may include an analog-to-digital converter 246, a microcontroller 248, and input/output ports 250.

The strain gauge amplifier 240 of the processing and control apparatus 103 is used to amplify the electric signals transmitted by the strain gauges 202, 222 of the probes 101, 102 and the temperature sensor amplifier 242 of the processing and control apparatus 103 is used to amplify the electric signals transmitted by the temperature sensors 202, 222 of the probes 101, 102. For example, the amplifiers 240, 242 may be any amplifier capable of providing gain to a signal as would be known to one skilled in the art. After the signals have been amplified, the amplified signals may be transmitted to the analog-to-digital converter 246 of the processing and control apparatus 103. The amplifiers 240, 242 may be one amplifier with multiple interfaces or a single amplifier that may be time-shared. Further, for example, the amplifiers 240, 242 may be integrated into the microcontroller 248.

At least in one embodiment, the two probes 101, 102 may be mounted to an enclosure that houses strain gauge signal processors and a microcomputer. Further, this enclosure may be mounted through an aircraft's skin at a forward portion of the fuselage or lower wing skin. However, the various elements of this system need not be contained in a particular housing or in a single housing, nor must the two probes be mounted to the same assembly.

The processing and control apparatus 103 may include an analog-to-digital converter 246 to receive amplified signals from the strain gauge amplifier 240 and the temperature sensor amplifier 242, the amplified signals representing the strain gauge 202, 222 and temperature sensor 204, 224 data. The analog-to-digital converter 246 may convert the amplified analog signals into digital data that is provided to the microcontroller 248 of the processing and control apparatus 103. For example, the analog-to-digital converter 240 may sample the signal with 6 to 24 bits of resolution at about 4 megahertz to about 64 megahertz.

The processing and control apparatus 103 may include input/output ports 250 to receive and/or transmit data to and from input/output devices 104. The input/output ports may be one or more simple electrical connections, or one or more standardized data connections, such as an RS-232 serial connection.

The processing and control apparatus 103 may include the microcontroller 248 to process the data from the probes 101, 102 and control the ice detection apparatus 100. The microcontroller 248 may be a digital microprocessor, a field-programmable gate array, an analog circuit, an application-specific integrated circuit (ASIC), and/or any other equivalent known to one skilled in the art that can provide one or more functions associated with ice detection as presented herein. In other words, the functionality provided by the processing and control apparatus 103 may be provided by a digital and/or analog implementation (e.g., using hardware and/or software).

Generally, the microcontroller 248 is coupled to the analog-to-digital converter 246 to receive data representative of at least the strain on the probe elements 200, 220. Further, for example, the data received may also be representative of the temperature of the probe elements 200, 220. The microcontroller 248 may include an analog-to-digital converter, amplifiers and/or input/output ports, in which case, a separate analog-to-digital converter 240, separate amplifiers 240, 242, and/or input/output ports 250 may not be needed. The microcontroller 248 may be electrically coupled to a switchable power source 244 that may electrically power the heating elements 206, 226 of the probes 101, 102, respectively.

The microcontroller 248 may be capable of controlling one or more functions associated with the apparatus 100. For example, the microcontroller 248 may be capable of adjusting the switchable power source 244 so as to control the heating elements 206, 226, and thus the temperature thereof. However, the microcontroller 248 may be also capable of controlling other systems of the aircraft. For example, the microcontroller 248 may be capable of activating an engine and/or wing de-icing apparatus. Also, for example, the microcontroller 248 may prompt a user, e.g., a pilot, to manually activate a de-icing apparatus.

The input/output ports 250 of the processing and control apparatus 103 provide a connection to input/output devices 104. For example, the input/output devices 104 (e.g., systems, controllers, etc.) may include an ice detection indicator 260, an ice detection apparatus on/off switch 262, an ice detection apparatus reset switch 264, an ice detection apparatus standby indicator 266, a de-icing interface, multi-function display presentation, and/or any other input/output device known to one skilled in the art.

The ice detection indicator 260 may indicate to a user, e.g., a pilot, when the ice detection apparatus 100 detects ice formation on the collection probe element 220. When the ice detection apparatus 100 no longer detects ice formation, the ice detection indicator 260 may turn “off” so as to no longer indicate the detection of ice formation. The ice detection apparatus 100 standby indicator 266 may indicate to a user when the ice detection apparatus 100 is in a “ready” state. For example, the indicators 260, 266 may be lights, e.g., light emitting diodes, located on an instrument panel within the cockpit of the aircraft upon which the ice detection apparatus 100 is mounted. Further, the indicators 260, 266 may be an auditory alert as opposed to visual alert, such as a distinctive beep or a voice. Yet further, for example, the indicators 260, 266 need not be discrete or binary; instead, the indicators may display a range of values depending on, for example, the amount of ice present on the collection probe element 220 or the ready-ness of the apparatus 100. For example, the indicators 260, 266 may be displayed on a liquid crystal display, an analog dial, an analog gauge, multi-function display presentation, a caution and warning display, and/or any other indicating device known to one skilled in the art.

The ice detection apparatus on/off switch 262 may allow a user to turn the ice detection apparatus “on” or “off.” The ice detection apparatus reset switch 264 may allow a user to reset the ice detection apparatus to a “start” state. The switches 262, 264 may be, for example, push button switches, toggle switches, in-line switches, rocker switches, membrane switch, and/or any other device known to one skilled in the art.

FIG. 2 also shows the aircraft electrical power 280. At least in one embodiment, the processing and control apparatus 103 is coupled to the aircraft electrical power 280 to provide electricity to the processing and control apparatus 103. The aircraft electrical power 280 may also supply power to other parts of the ice detection apparatus 100 such as the probes 101, 102 and/or the input/output devices 104. The aircraft electrical power 280 may be the aircraft's primary electrical power source, secondary electrical power source, and/or a standby battery.

FIG. 3 shows a perspective view of an exemplary embodiment of a reference probe and a collection probe mounted for use in an ice detection apparatus such as shown generally in FIGS. 1 and 2 according to the present invention. Ice detection apparatus 300 of FIG. 3 includes a housing 302 used to mount a reference probe 320 and a collection probe 340.

The reference probe 320 includes a reference probe element 322, a strain gauge 324, a reference probe lower portion 326, and reference probe fasteners 306. The collection probe 340 includes a collection probe element 342, a strain gauge 344, a collection probe lower portion 346, and collection probe fasteners 308.

The probe elements 322, 342 are rigidly coupled to their respective lower portions 326, 346 with probe fasteners 306, 308. Probe fasteners 306, 308 may be may be rivets, bolts, friction staking, welds, brazed joints, and/or any other fastener known to one skilled in the art. The lower portions 326, 346 are rigidly coupled to a support structure 310. At least in one embodiment, the probe elements 322, 342 may be integral to their respective portions 326, 346. At least in one embodiment, the support structure 310 uses fasteners 304 to secure the probes 320, 340. Fasteners 304 may be rivets, bolts, friction staking, welds, brazed joints, and/or any other fasteners known to one skilled in the art. At least in one embodiment, the support structure 310 is formed out of an insulative material to thermally isolate the probe elements 322, 342. At least in one embodiment, probe elements 322, 342 are pressed into precision holes (e.g., where the holes are thermally insulated to thermally isolate the probe elements 322, 342).

In this particular exemplary embodiment, each of probe elements 322, 342 includes an elongate body extending along a respective axis 321, 341. The reference probe 320 and collection probe 340 are coupled to the support structure 310 such that the axes 321, 341 of the probe elements 322, 342 are parallel to one another. In such a manner, the probe elements 322, 342 can be presented in an air stream such that they are both exposed to substantially the same conditions. One will recognize that the probe elements 322, 342 are separated from one another. For example, they should be separated by a distance such that one will not interfere with the functionality of the other. For example, the presence of ice on the collection probe element 340 should not hinder operation of the reference probe element 320 and the continuous heating of the reference probe element 320 should not hinder the operation of the collection probe element 340.

In the embodiment shown in FIG. 3, probe elements 322, 342 have a flat first surface facing forward in the direction of aircraft movement and a rounded second surface facing rearward in the opposite direction (i.e., a semi-circle cross-section). Although the probe elements 322, 342 are shown in FIG. 3 to be of a particular size and shape and located in the same housing proximate each other, one will recognize the any suitable type of the probe elements may be used as described herein.

In this particular embodiment, the support structure 310 is rigidly coupled to the aircraft so as to allow the probe elements 322, 342 and strain gauges 324, 344 to operationally provide an indication of force moment on the probe elements 322, 342. The housing 302 encloses the lower portions 326, 346 of the probes 320, 340 and the support structure 310. The housing 302 may be formed of materials such as, but not limited to, steel, aluminum, titanium, scandium, a polymer, and/or any other material known to one skilled in the art. The exterior surface 311 of the housing 302 proximate the probe elements 322, 342 may be mounted flush with the skin of the aircraft as to not create any unnecessary aerodynamic drag. However, the housing 302 may be mounted protruding from or reside within the skin of the aircraft. Although the housing 302 is round in FIG. 3, the housing 302 may be of any shape and/or size.

Generally, the ice detection apparatus of the present invention, when the aircraft is in flight, detects the presence of ice on the collection probe element by comparing data representative of the force moment on each of the probe elements and monitoring such data to identify a significant difference in the force moment on the probes. Generally, the force moment on each of the probe elements corresponds to the aerodynamic drag on each of the probe elements (e.g., as ice accumulates on the collection probe element, the coefficient of drag and the projected area of the collection probe element will increase or decrease, which, in turn, will increase or decrease the aerodynamic drag on the collection probe element). If ice accumulates on the collection probe element while the reference probe element is heated, the difference in force moment on the two probes will be significant (e.g., the shape of the reference probe element without ice will have a significantly different coefficient of drag than the collection probe element upon which ice is formed), and, therefore, ice is detected on the collection probe element. If ice is detected on the collection probe element, icing conditions are favorable for ice formation on one or more surfaces of the aircraft.

The reference probe element may be continually heated to prevent ice formation thereon when the detection apparatus is in operation. The collection probe element may not be heated so that when icing conditions are present, the collection probe element will collect ice. When ice is formed on the collection probe element, the aerodynamic drag will either increase or decrease depending on many factors including, but not limited to, temperature, water droplet size, liquid water content, aircraft velocity, wind direction, wind velocity, shape of element with the ice thereon, collection of ice on particular portions of the element, and/or any other factor known to one skilled in the art. Further, as the aerodynamic drag changes, the force moment applied to the collection probe element will also change.

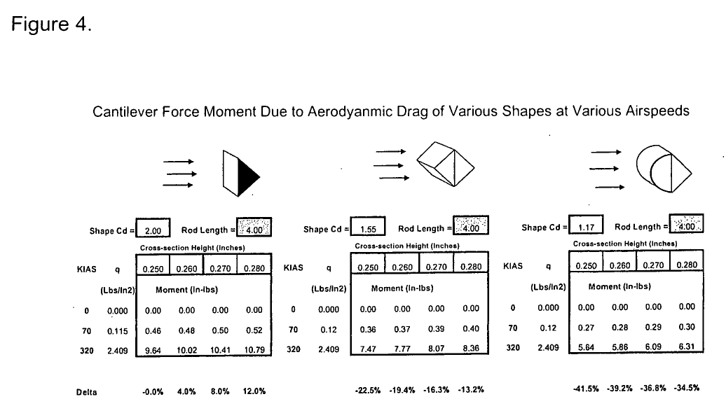

FIG. 4 shows an illustration disclosing cantilever force moment due to aerodynamic drag of various shapes at various airspeeds. The different shapes may be representative of ice accumulations on a probe element or the probe itself.

As shown in all three charts, the air speed (provided in knots indicated air speed (KIAS)) is directly related to the pressure force applied (q). As the air speed increases, so does the pressure force applied. Therefore, the charts show that: when air speed equals 0 knots, the pressure force applied equals 0 pounds per square inch; when air speed equals 70 knots, the pressure force applied equals 0.115 pounds per square inch; and, when air speed equals 320 knots, the pressure force applied equals 2.409 pounds per square inch.

As disclosed in the leftmost chart, a four-inch long rod having a forward-facing flat surface (i.e., a forward-facing surface that lies in a plane parallel to the element axis and normal to the generally forward motion of the aircraft) and a rearward-facing triangular surface has a coefficient of drag (Cd) of 2.0. As the cross-section height of the forward-facing flat surface increases and the air speed increases, the force moment increases accordingly. For example, with this orientation, i.e., a forward-facing surface that lies in a plane parallel to the element axis and normal to the generally forward motion of the aircraft, initial accumulation of ice will almost always cause the co-efficient of drag to be reduced.

As disclosed in the middle chart, a four-inch long rod having a forward-facing triangular surface (i.e., a forward-facing surface that lies in a plane parallel to the element axis and normal to the generally forward motion of the aircraft) and a rearward-facing triangular surface has a coefficient of drag of 1.55. As the cross-section height of the forward-facing triangular surface increases and the air speed increases, the force moment increases accordingly. The force moments created by this shape, i.e., a forward-facing triangular surface, are less than the force moments created by the forward-facing flat surface disclosed in the leftmost chart.

As disclosed in the rightmost chart, a four-inch long rod having a forward-facing semicircular surface (i.e., a forward-facing surface that lies in a plane parallel to the element axis and normal to the generally forward motion of the aircraft) and a rearward-facing triangular surface has a coefficient of drag of 1.17. As the cross-section height of the forward-facing semicircular surface increases and air speed increases, the force moment increases accordingly. The force moments created by this shape, i.e., a forward-facing semicircular surface, are less than the force moments created by the shapes disclosed in the middle and leftmost chart.

The delta values are the percent difference between the baseline force moment of 9.64 inch-pounds and the subsequent force moment values created when the probe is extended into a airstream of 320 KIAS (knots indicated air speed), which creates a 2.409 pounds per square inch force. The baseline force moment represents a four-inch probe with forward-facing flat surface and a rearward-facing triangular surface and having a cross-section height of 0.250 inches (i.e., a one square inch, forward-facing surface area) being free of ice.

As shown in the leftmost chart, when the cross-section height of the forward-facing flat surface is increased from 0.250 inches to 0.280 inches, which may represent an accumulation of ice, the force moment increases by 12.0% (i.e., the delta value).

As shown in the middle chart, a forward-facing triangular surface having a 0.250 inch cross-section height, which may represent an accumulation of ice, decreases the force moment 22.5% from the forward-facing flat surface of the leftmost chart. As such, a forward-facing triangular surface is more aerodynamic. Further shown in the middle chart, when the cross-section height of the forward-facing triangular surface is increased from 0.250 to 0.280, which may represent an accumulation of ice, the force moment increases to −13.2% different than the forward-facing flat surface with a cross-section height of 0.250 inches of the leftmost chart.

As shown in the rightmost chart, a forward-facing semicircular surface having a 0.250 inch cross-section height, which may represent an accumulation of ice, decreases the force moment 41.5% from the forward-facing flat surface of the leftmost chart. As such, a forward-facing semicircular surface is more aerodynamic that both the forward-facing flat and triangular surfaces of the leftmost and middle charts. Further shown in the rightmost chart, when the cross-section height of the forward-facing semicircular surface is increased from 0.250 to 0.280, which may represent an accumulation of ice, the force moment increases to −34.5% different than the forward-facing flat surface with a cross-section height of 0.250 inches of the leftmost chart.

Therefore, the charts in FIG. 4 show that the force moment applied to a four-inch long probe element by aerodynamic drag will significantly numerically change when the shape of the forward-facing surface is modified and/or the cross-section height of the forward-facing surface is modified. Although these charts only disclose modifying the shape of the forward-facing surface and the cross-section height of the forward-facing surface, a multitude of other modifications exist that will vary the amount of aerodynamic drag on the probe. For example, the rearward-facing surface may be modified to affect the aerodynamic drag on the probe. Also, for example, the forward-facing surface may have apertures or be textured.

In summary, the charts in FIG. 4 show that as the coefficient of drag of a probe increases or decreases, the aerodynamic drag on the probe will increase or decrease accordingly. In turn, as the aerodynamic drag on the probe increases or decreases, the force moment applied to the probe will increase or decrease accordingly. Therefore, regardless of the shape or size of the probe, as ice accumulates on the probe, the force moment will either increase or decrease indicating that the probe may have accumulated ice.

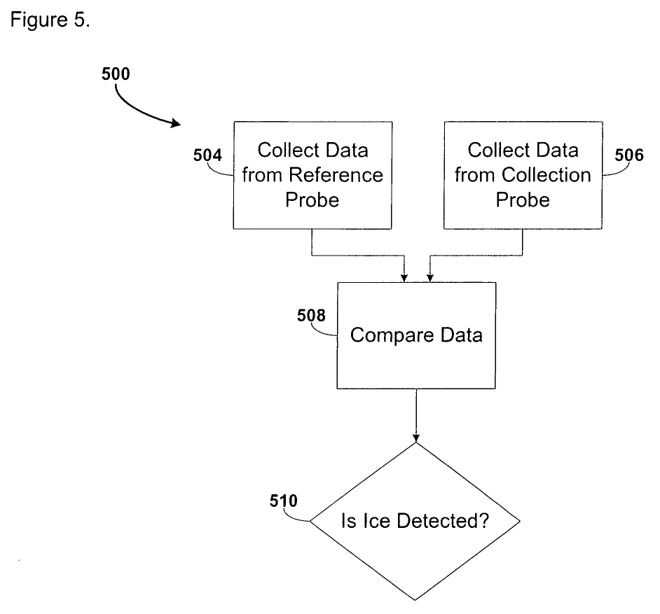

FIG. 5 shows a block diagram of one general embodiment of an ice detection method 500 according to the present invention that may be implemented by an ice detection apparatus such as shown in FIGS. 1-3. In blocks 504 and 506, data is collected from the reference probe 101 (e.g., as the reference element thereof is heated so as to prevent ice accumulation thereon) and the collection probe 102 (e.g., an unheated collection probe). For example, the data may be collected from the strain gauges associated with the probes and representative of the force moment applied to the mounted probe elements by the processing and control apparatus 103. For example, the cantilever force moment data may represent the aerodynamic drag on the probe elements. In other words, as shown herein with reference to FIG. 4, as ice is accumulated on the collection probe element, the coefficient of drag of the collection probe element changes due to the ice accumulation, and, therefore, the cantilever force moment, on the probe changes.

In block 508, the data collected from the reference probe 101 and the collection probe 102 is compared. Further, in decision block 510, it is determined if ice is detected on the collection probe 102 based on the comparison.

At least in one embodiment, the processing and control apparatus 103 may average the data from each probe over a period of time (e.g., to remove oscillations in the aerodynamic force applied to the probes). For example, data may be averaged over the previous about ¼ second to about 4 seconds. However, other normalization techniques may be used such as electronic filtering, mechanical damping, etc. Then, the averaged measurements representative of force moment on the probes may be compared.

At least in another embodiment, the processing and control apparatus 103 may determine whether the force moment applied to the collection probe is different than that applied to the reference probe, and determine if the difference is sufficient to indicate a presence of ice on the collection probe (e.g., compare the difference to a predetermined limit). For example, if the cantilever force moment on the collection probe 102 is significantly different than the cantilever force moment on the reference probe 101, the processing and control apparatus 103 will determine that ice is present on the collection probe 102. For example, if the force moment on the collection probe 102 is different than the cantilever force moment on the reference probe by about 1% to about 3% or greater, then ice is determined to be present on the collection probe.

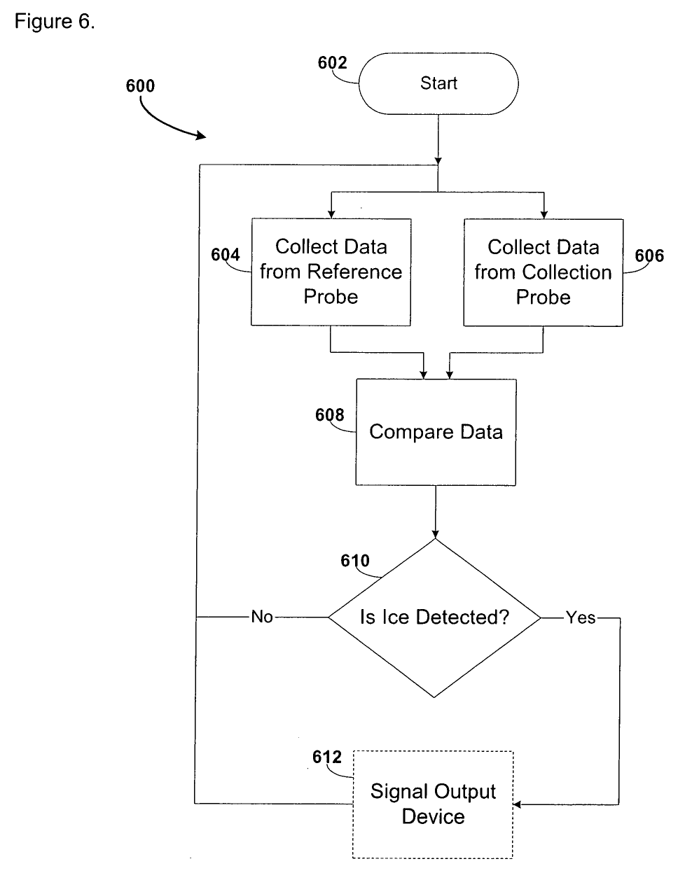

FIG. 6 shows a block diagram of another embodiment of an ice detection method 600 according to the present invention that may be implemented by an ice detection apparatus such as shown in FIGS. 1-3.

The ice detection method 600 is activated (oval 602) (e.g., by a user flipping an on/off switch). In block 604, data is collected from the reference probe 101 while the reference element thereof is heated so as to prevent ice accumulation thereon. Further, simultaneously, data is also collected from an unheated collection probe 102 (block 606).

In block 608, the data collected from the reference probe 101 and the collection probe 102 is compared (e.g., to determine whether ice accumulation on the unheated collection probe has changed the coefficient of drag of the collection probe relative to the heated reference probe). Using such comparison, in block 610, it is determined if ice is detected on the collection probe 102 as described herein. For example, if there is a significant difference between the force moment on the collection probe 102 relative to the reference probe 101, such a difference indicates a difference of aerodynamic drag on the probes and, as such, indicates that the shape of the collection probe has changed due to ice accumulation thereon. At least in one embodiment, data is collected from the reference probe and the collection probe after determining that ice is present on the collection probe element to confirm the presence of ice on the collection probe element (e.g., to verify that the ice detection apparatus has not produced a false positive).

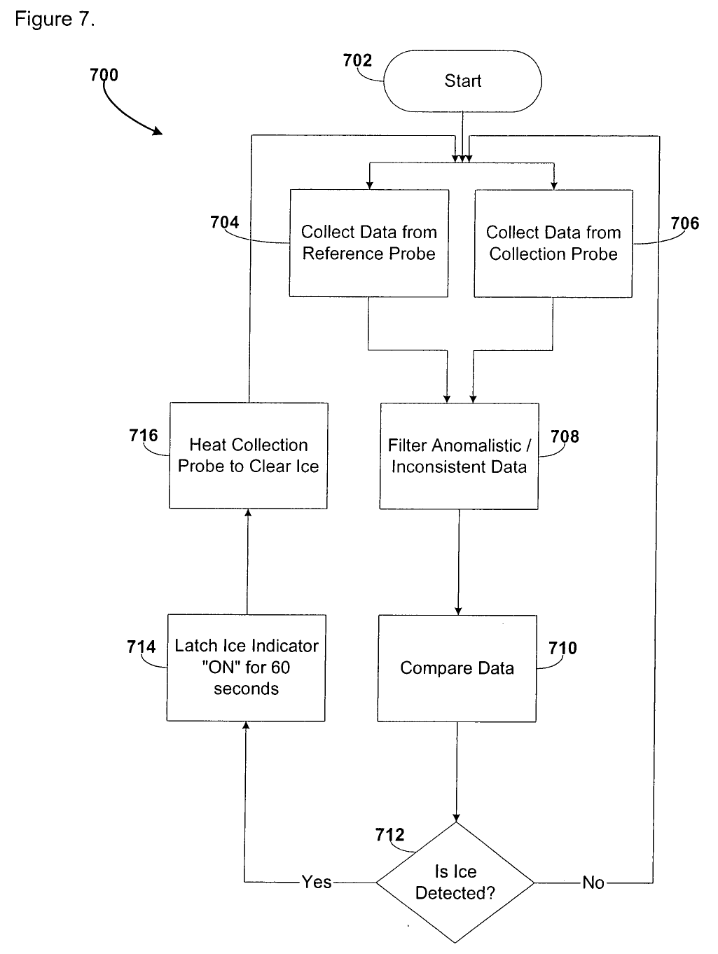

In block 612, an output device is signaled if ice was determined to be present in block 610. For example, the processing and control apparatus 103 may latch an ice detection indicator as shall be described with reference to FIG. 7. After latching an output device, the method 600 returns to the collection of data from the reference probe and collection probe (blocks 604 and 606).

However, if ice was determined to not be present in block 610, the method 600 will bypass block 612 and continues collecting data from the reference probe and collection probe (blocks 604 and 606). The cycle of method 600 repeats until terminated (e.g., either automatically, such as in a fault condition, or manually, such as by a pilot).

FIG. 7 shows a block diagram of yet another embodiment of an ice detection method 700 according to the present invention that may be implemented by an ice detection apparatus such as shown in FIGS. 1-3. Upon activation (start oval 702), data from the reference probe 101 and the collection probe 102 is collected (blocks 704 and 706).

In block 708, the data collected from the probes 101, 102 may be optionally filtered to remove anomalies and inconsistencies. For example, the processing and control apparatus 103 may discard data that increases or decreases greater than about 1% per about 1 second. To filter the data, the processing and control apparatus 103 may use an analog electronic circuit (e.g., a band pass filter), a digital circuitry, filtering algorithms, and/or any other filtering device known by one in the art.

In block 710, the data collected from the reference probe 101 and the collection probe 102 is compared. For example, in one embodiment, the processing and control apparatus 103 may determine whether the force moment applied to the collection probe is different than that applied to the reference probe, and determine if the difference is sufficient to indicate a presence of ice on the collection probe. Based on the comparison, it is determined if ice is present on the collection probe 102 (decision block 712) as previously described herein. For example, anomalistic and inconsistent data that was discarded in block 708 is generally not considered in the comparison or determination that ice is present.

If ice was determined to not be present (block 712), the method 700 bypasses blocks 714 and 716 and returns to the collection of data from the reference probe and collection probe (block 704, 706).

However, if ice was determined to be present (block 712) for about 2 to about 4 seconds, the method 700 may latch an ice indicator “ON” for period of time (e.g., sixty seconds) (block 714). It will be readily apparent that the latch time period may vary. For example, in one or more embodiments, the ice indicator may be latched on for about 30 seconds to about 90 seconds.

Upon latching the ice indicator (block 714), the heating element of the collection probe 102 is activated to heat the collection probe element so as to clear all the ice from the collection probe element (block 716). For example, the collection probe element may be heated to about 90 degrees Fahrenheit to about 120 degrees Fahrenheit for about 10 seconds to about 20 seconds. However, depending on the environmental conditions, the heating element of the collection probe 102 may be heated at a higher or lower temperature for a shorter or longer period of time. Further, such heating may occur simultaneously with the latching of the ice indicator or immediately thereafter. After clearing the ice from the collection probe 102, data is then again collected from the reference probe and collection probe (blocks 704, 706).

During subsequent cycles following the latching of the ice indicator (e.g., latched for 60 seconds), if ice is again detected on the collection probe 102, the ice indicator is again latched for a time period (e.g., 60 seconds) and the collection probe is heated to remove ice accumulation. In other words, the ice indicator continues to be latched if ice continues to be detected on the collection probe 102. However, if, during subsequent cycles following the latching of the ice indicator (e.g., latched for 60 seconds), ice is no longer detected during the entire latch period, the latch period will run to completion and the ice indicator will turn off. One will recognize that this is only one exemplary embodiment of the operation of an indication device and that such indication may be provided in various manners (e.g., simple switch of the ice indicator on and requiring a manual switch off, etc.).

A complete cycle of method 700 when ice is not detected may take about 10 seconds to about 60 seconds. A complete cycle of method 700 when ice is detected and, subsequently, the collection probe element is cleared of ice may take about 60 seconds to about 90 seconds. However, depending on the environmental conditions, a complete cycle of method 700 may take a shorter or longer period of time to complete.

At least in one embodiment, the unheated probe, e.g., the collection probe, will tend to accrete ice when moisture and sufficiently low atmospheric temperatures exist. A comparison of the bending moment of each probe may indicate a difference when the coefficient of drag changes significantly. In order to nullify the effects of turbulence, measurements used may need to be a running average over, at least, the previous 2 seconds (e.g., any oscillations in aerodynamic force can be normalized by various methods, such as electronic filtering, mechanical damping, etc.). The magnitude of the strain oscillation, due to turbulence may need to be significantly less than the magnitude of comparative difference, so as to provide a reliable ice indication warning. It will be recognized that, as the aircraft's speed changes, the bending moments of both probes should change equally, unless the coefficient of drag of the collection probe changes due to ice accumulation thereon.

Further, at least in one embodiment, if a discernable difference in strain is detected, for a 60 second time period, a latching signal may be sent to a cockpit indicator (e.g., an ice indicator may be latched) to enunciate “Ice Detected” (e.g., “Ice Detected” can be any discrete output that can be used for any form of enunciation). This 60 second time period can be whatever is needed to provide a warning that is consistent with the needs of the application. This mode may be maintained until the system proves that the icing condition is no longer present. Further, after sending the latching signal, the collection probe is heated to clear any ice. Once cleared, the processing and control apparatus may measure the strains of each probe and mathematically normalize the difference, thereby re-calibrating the instrument. However, the system may also function without periodic calibration, but, re-calibration may allow for reduced accuracy requirements of other system elements. Then, the system may continue to monitor for ice (e.g., during the 60 seconds). If ice is again detected, the enunciation continues. If there is not a significant change in the coefficient of drag between the collection probe and the reference probe, the “Ice Detected” enunciator may be extinguished.

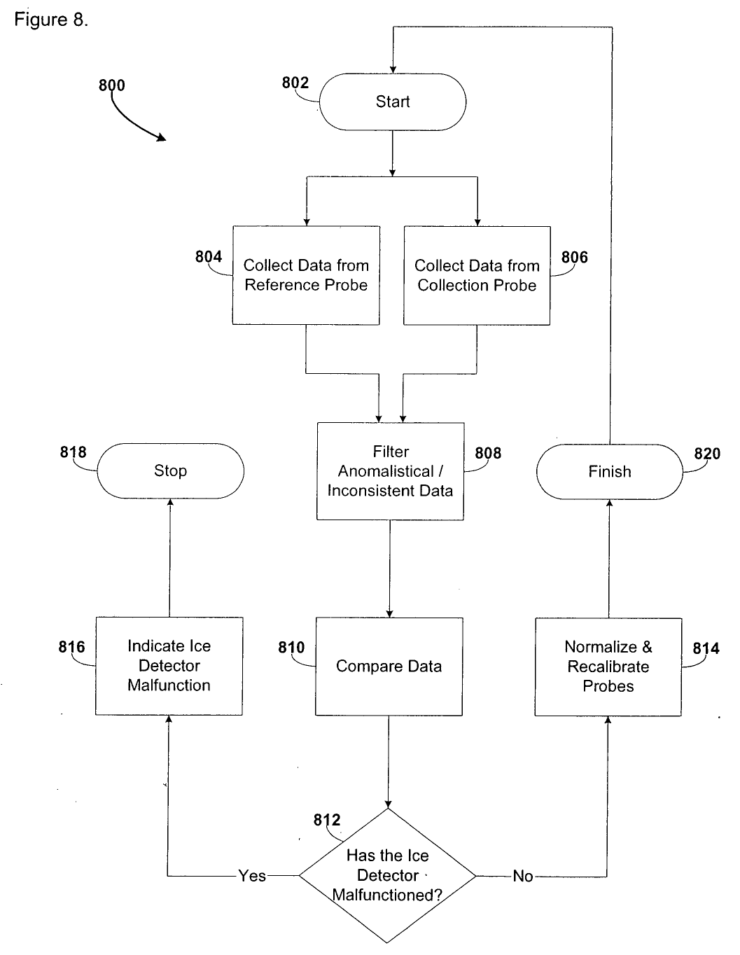

FIG. 8 shows a block diagram of one embodiment of an ice detection apparatus malfunction detection method 800 according to the present invention that may be implemented by an ice detection apparatus such as shown in FIGS. 1-3. For example, one or more of the functions of this method 800 may be executed simultaneously with the ice detection methods described herein, using the same or different data than collection for the ice detection methods, and/or after the collection probe has been heated to clear all the ice on the collection probe element (e.g., as described in reference to FIG. 7)

This method 800 detects if the ice detection apparatus has malfunctioned. The ice detection apparatus may malfunction due to electronic failure, structural failure, foreign debris (e.g., a bird carcass) collected on a probe, electrical short circuit, software failure, strain gage failure, temperature gauge failure, and/or any other malfunction known to one skilled in the art.

As shown in FIG. 8, upon initiation (start oval 802), data from the reference probe 101 and the collection probe 102 is collected (blocks 804 and 806). In block 808, the data collected from the probes 101, 102 is filtered to remove anomalies and inconsistencies as described herein.

In one or more embodiments, the data is analyzed and/or compared to detect malfunction in the ice detection system. For example, the data may be analyzed to determine if a proper signal is being received from either the reference and/or collection probe, or whether temperatures thereof are being controlled properly.

As least in one embodiment, the data collected from the probes 101, 102 is compared (block 810) to determine if the ice detection apparatus has malfunctioned (block 812). For example, if the cantilever force moments on the reference probe 101 and the collection probe 102, immediately following the heating of collection probe 102, differ by more than about 3%, then the ice detection apparatus has probably malfunctioned.

If the ice detection apparatus was determined to have malfunctioned, the method 800 indicates that the ice detection apparatus has malfunctioned as shown by block 816. For example, the ice detection apparatus malfunction indicator may be a light, e.g., a light emitting diode, located on the instrument panel. The ice detection apparatus malfunction indicator may be any of a multitude of different types of indicators as described herein in reference to the ice detection indicator 260. After indicating ice detection apparatus malfunction, the method 800 may stop as shown by block 818. Likewise, the ice detection method is also terminated due to malfunction. However, data may continue to be collected to determine if the malfunction disappears.

After the ice detection apparatus has malfunctioned, a user, e.g., a pilot, may choose to turn the system “off,” reset the apparatus, force a probe recalibration and nonmalization, and/or force both probes 101, 102 to be re-heated to remove ice or debris.

If the ice detection apparatus was determined to not have malfunctioned, then the method 800 will normalize and recalibrate the probes 101, 102 in block 814. After the probes 101, 102 have been nonmalized and recalibrated, the method 800 finishes and may return to the beginning of the method 800.

The complete disclosure of the patents, patent documents, and publications cited in the Background, the Summary, the Detailed Description of Exemplary Embodiments, and elsewhere herein are incorporated by reference in their entirety as if each were individually incorporated. Exemplary embodiments of the present invention are described above. Those skilled in the art will recognize that many embodiments are possible within the scope of the invention. Other variations, modifications, and combinations of the various components and methods described herein can certainly be made and still fall within the scope of the invention. Thus, the invention is limited only by the following claims and equivalents thereto.

What is claimed is:

1. An ice detection apparatus comprising:
a reference probe comprising a reference probe element;
a collection probe comprising a collection probe element, wherein the collection probe element is of the same configuration as the reference probe element; and
a processing and control apparatus configured to receive data from the reference probe and the collection probe, wherein the processing and control apparatus compares the data from the reference probe and the collection probe to detect the presence of ice on the collection probe element.

2. The apparatus according to claim 1, wherein the reference probe and the collection probe each further comprise a strain gauge and a heating element.

3. The apparatus according to claim 1, wherein the reference probe and the collection probe each further comprise a temperature sensor.

4. The apparatus according to claim 1, wherein the processing and control apparatus further comprises an output port coupled to an ice detection indicator.

5. The apparatus according to claim 1, wherein the reference probe and the collection probe are configured to be mounted on an aircraft such that both the reference probe element and the collection probe element are in a same airstream when the aircraft is in flight.

6. The apparatus according to claim 1, wherein the reference probe element is continually heated to prevent ice formation thereon when the data is collected from the reference probe and the collection probe.

7. The apparatus according to claim 1, wherein the data received from the reference probe and the collection probe comprises data representative of a cantilever force moment on each of the reference probe element and the collection probe element.

8. The apparatus according to claim 1, wherein the data received from the reference probe and the collection probe comprises data representative of an aerodynamic drag on each of the reference probe and the collection probe.

9. The apparatus according to claim 1, wherein the processing and control apparatus is configured to monitor a difference between a first aerodynamic drag on the reference probe element and a second aerodynamic drag on the collection probe element with or without ice accumulation thereon.

10. An ice detection apparatus comprising:
a reference probe comprising a reference probe element;
a collection probe comprising a collection probe element, wherein the reference probe and the collection probe are configured to be mounted on an aircraft such that both the reference probe element and the collection probe element have substantially identical exposure to an airstream when the aircraft is in flight; and
a processing and control apparatus configured to receive data from the reference probe and the collection probe representative of aerodynamic drag on the reference probe element and the collection probe element, wherein the processing and control apparatus compares the data from the reference probe and the collection probe to detect the presence of ice on the collection probe element.

11. The apparatus according to claim 10, wherein the reference probe and the collection probe each further comprise a strain gauge and a heating element.

12. The apparatus according to claim 10, wherein the reference probe and the collection probe each further comprise a temperature sensor.

13. The apparatus according to claim 10, wherein the reference probe element and the collection probe element are substantially physically identical.

14. The apparatus according to claim 10, wherein the processing and control apparatus further comprises an output port coupled to an ice detection indicator.

15. The apparatus according to claim 10, wherein the reference probe element is continually heated to prevent ice formation thereon when the data is collected from the reference probe and the collection probe.

16. The apparatus according to claim 10, wherein the data received from the reference probe and the collection probe comprises data representative of a cantilever force moment on each of the reference probe element and the collection probe element.

17. An ice detection apparatus comprising:
a reference probe comprising: a reference probe element; a force moment detection device for use in detecting a force moment applied to the reference probe element when the reference probe is mounted; and a heating element to heat the reference probe element; and
a collection probe comprising a collection probe element and a force moment detection device for use in detecting a force moment applied to the collection probe element when the collection probe is mounted.

18. The apparatus according to claim 17, wherein the collection probe element is of the same configuration as the reference probe element.

19. The apparatus according to claim 17, wherein the force moment detection device of each of the reference probe and the collection probe comprises a strain gauge.

20. The apparatus according to claim 17, wherein the collection probe comprises a heating element to heat the collection probe element.

21. The apparatus according to claim 17, wherein each of the reference probe and the collection probe comprises a temperature sensor.

22. The apparatus according to claim 17, wherein the collection probe and the reference probe are coupled to a mounting structure configured to be mounted on an aircraft such that both the reference probe element and the collection probe element have substantially identical exposure to an airstream when the aircraft is in flight.

23. A method for detecting the presence of ice formation on an aircraft in flight comprising:
providing a reference probe comprising a reference probe element;
providing a collection probe comprising a collection probe element, wherein the reference probe element and the collection probe element are mounted on an aircraft such that they both have substantially identical exposure to an airstream when the aircraft is in flight;
collecting data from the reference probe and the collection probe representative of aerodynamic drag on each of the reference probe element and the collection probe element; and
determining if ice is present on the collection probe element based on the data collected from the reference probe and the collection probe.

24. The method according to claim 23, wherein the method further comprises heating the reference probe element to prevent ice formation thereon while allowing ice to form on the collection probe element.

25. The method according to claim 23, wherein the data representative of the aerodynamic drag on each of the reference probe element and the collection probe element comprises data representative of a cantilever force moment on the reference probe element and the collection probe element.

26. The method according to claim 23, wherein the method further comprises continuing to collect data from the reference probe and the collection probe after determining that ice is present on the collection probe element to confirm the presence of ice on the collection probe element.

27. The method according to claim 23, wherein the method further comprises providing an indication that ice is detected on the collection probe element

28. The method according to claim 23, wherein the method further comprises:
heating the collection probe element to remove ice accumulated on the collection probe element after ice is detected;
continuing to collect the data from the reference probe and the collection probe after heating the collection probe element; and
determining if ice is present on the collection probe element after heating the collection probe element.

29. The method according to claim 23, wherein the method further comprises monitoring the data from the reference probe and the collection probe to detect if either the reference probe or the collection probe have malfunctioned.

30. A method for detecting the presence of ice formation on an aircraft in flight comprising:
providing a reference probe comprising a reference probe element;
providing a collection probe comprising a collection probe element;
heating the reference probe element to prevent ice formation thereon while allowing ice to form on the collection probe element;
collecting data from the reference probe and the collection probe; and
determining if ice is present on the collection probe based on the data collected from the reference probe and the collection probe.

31. The method according to claim 30, wherein the reference probe and the collection probe are configured to be mounted on the aircraft such that both the reference probe element and the collection probe element are in a same airstream when the aircraft is in flight.

32. The method according to claim 30, wherein the data collected from the reference probe and the collection probe comprises data representative of a cantilever force moment on each of the reference probe element and the collection probe element.

33. The method according to claim 30, wherein the method further comprises continuing to collect the data from the reference probe and the collection probe after determining that ice is present on the collection probe element to confirm the presence of ice on the collection probe element.

34. The method according to claim 30, wherein the method further comprises providing an indication that ice is detected on the collection probe element.

35. The method according to claim 30, wherein the method further comprises:
heating the collection probe element to remove ice accumulated on the collection probe element after ice is detected;
continuing to collect the data from the reference probe and the collection probe after heating the collection probe element; and
determining if ice is present on the collection probe element after heating the collection probe element.

36. The method according to claim 30, wherein the method further comprises monitoring the data from the reference probe and the collection probe to detect if either the reference probe or the collection probe have malfunctioned.

37. A system for detecting the presence of ice on an aircraft in flight, comprising:
a reference probe comprising a reference probe element and a force moment detection device for use in detecting the force moment applied to the reference probe element when the reference probe is mounted;
a collection probe comprising a collection probe element and a force moment detection device for use in detecting the force moment applied to the collection probe element when the collection probe is mounted, wherein the collection probe element is of the same configuration as the reference probe element;
a mounting structure configured to mount the reference probe and the collection probe on an aircraft such that both the reference probe element and the collection probe element have substantially identical exposure to an airstream when the aircraft is in flight; and
a processing and control apparatus configured to receive data from the reference probe and the collection probe representative of the force moment applied to the reference probe element and the collection probe element, wherein the processing and control apparatus compares the data from the reference probe and the collection probe to determine a difference between the force moment on the reference probe element and the force moment on the collection probe element so as to detect the presence of ice on the collection probe element when the aircraft is in flight.

38. The system according to claim 37, wherein the system further comprises an indication apparatus to provide an indication when ice is detected on the collection probe element.

39. The system according to claim 37, wherein the system further comprises a de-icing apparatus.

40. The system according to claim 37, wherein the force moment detection device of each of the reference probe and the collection probe comprises a strain gauge.

41. The system according to claim 37, wherein the reference probe comprises a heating element to heat the reference probe element, and further wherein the collection probe comprises a heating element to heat the collection probe element.
